(19) United States
(12) Patent Application Publication
(10) Pub. No.: US 2018/0040001 A1
(43) Pub. Date: Feb. 8, 2018

(54) SEGMENTING PAID VERSUS ORGANIC VIEWS OF VIDEO CONTENT ITEMS

(71) Applicants: Ozgur Sahin, San Francisco, CA (US); Thomas J. Broxton, San Francisco, CA (US); Lane P. Shackleton, San Francisco, CA (US)

(72) Inventors: Ozgur Sahin, San Francisco, CA (US); Thomas J. Broxton, San Francisco, CA (US); Lane P. Shackleton, San Francisco, CA (US)

(21) Appl. No.: 13/241,783

(22) Filed: Sep. 23, 2011

(51) Int. Cl. G06Q 30/02

(52) U.S. Cl. CPC G06Q 30/0201; G06Q 30/0242

(57) ABSTRACT

Methods, systems, and apparatus, including computer programs encoded on a computer-readable storage medium, including a method for identifying and presenting view information for a video content item. The method comprises identifying view data for a video content item, segmenting the view data to create a segmentation that compares paid views versus organic views, and presenting the segmented view data to a user.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Content item slots can be allocated to content sponsors through an auction. For example, content sponsors can provide bids specifying amounts that the sponsors are respectively willing to pay for presentation of their content. In turn, an auction can be performed, and the slots can be allocated to sponsors according, among other things, to their bids and/or the relevance of the sponsored content to content presented on a page hosting the slot or a request that is received for the sponsored content. Some content items, such as video content items (e.g., video advertisements) can be viewed separately, or organically, e.g., without being associated with a paid advertisement.

### SUMMARY

In general, one innovative aspect of the subject matter described in this specification can be implemented in methods that include a method for identifying and presenting view information for a video content item. The method comprises identifying view data for a video content item, segmenting the view data to create a segmentation that compares paid views versus organic views, and presenting the segmented view data to a user.

These and other implementations can each optionally include one or more of the following features. The method can further comprise applying a filter to the segmented view data and presenting one or more filtered sub-segments of the segmented view data to the user. The filter can be a demographic filter, and presenting one more filtered sub-segments can include presenting both organic view data and paid view data in accordance with the demographic filter. The filter can be a location filter, and presenting one more filtered sub-segments can include presenting both organic view data and paid view data in accordance with the location filter. The filter can be a time period filter, and presenting one more filtered sub-segments can include presenting both organic view data and paid view data in accordance with the time period filter. The filter can be a quartile or dwell time filter, and presenting one more filtered sub-segments can include presenting both organic view data and paid view data in accordance with the quartile or dwell time filter. The view data can include both paid view data for paid presentations of the video content item and organic view data for views of the video data directly through a video sharing environment. Presenting the segmented view data can include presenting the segmented view data in a graph. Presenting the segmented view data can include presenting the segmented view data in a tabular form. The method can further comprise further segmenting the segmented view data to include one or more segments that reflect view statistics of paid versus organic views for at least one or more of the following further segments comprising demographics, time period, location, or dwell time.

In general, another innovative aspect of the subject matter described in this specification can be implemented in systems that include a system for presenting segmented view data to a user. The system comprises a content management system that provides content items responsive to received requests. The content management system includes a paid view information collector that collects and identifies paid view data for a video content item including view information corresponding to paid views of the video content item. The content management system further includes a video hosting site that supports hosting, uploading and watching videos, the video hosting site including an organic view information collector that collects and identifies organic view data for a video content item including view information corresponding to organic views of the video content item. The content management system further includes a sponsor interface, displayable on a user device, for presenting the segmented view data to a user, the sponsor interface including a view information segregator that segments the collected and identified paid and organic view data to create a segmentation that compares paid views versus organic views of the video content item.

These and other implementations can each optionally include one or more of the following features. The view information segregator can further apply a filter to the segmented view data and present one or more filtered sub-segments of the segmented view data for use in the sponsor interface.

In general, another innovative aspect of the subject matter described in this specification can be implemented in computer program products that include a computer program product tangibly embodied in a computer-readable storage device and comprising instructions that, when executed by a processor, cause the processor to identify view data for a video content item, segment the view data to create a segmentation that compares paid views versus organic views, and present the segmented view data to a user.

These and other implementations can each optionally include one or more of the following features. The computer program product further comprises instructions to apply a filter to the segmented view data and present one or more filtered sub-segments of the segmented view data to the user. The filter can be a demographic filter, and presenting one more filtered sub-segments can include presenting both organic view data and paid view data in accordance with the demographic filter. The filter can be a location filter, and presenting one more filtered sub-segments can include presenting both organic view data and paid view data in accordance with the location filter. The filter can be a time period filter, and presenting one more filtered sub-segments can include presenting both organic view data and paid view data in accordance with the time period filter. The filter can be a quartile or dwell time filter, and presenting one more filtered sub-segments can include presenting both organic view data and paid view data in accordance with the quartile or dwell time filter. The view data can include both paid view data for paid presentations of the video content item and organic view data for views of the video data directly through a video sharing environment. Presenting the segmented view data can include presenting the segmented view data in a graph. Presenting the segmented view data can include presenting the segmented view data in a tabular form. The computer program product further comprises instructions to further segment the segmented view data to include one or more segments that reflect view statistics of paid versus organic views for at least one or more of the following further segments comprising demographics, time period, location, or dwell time.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for serving content.

FIGS. 2A-2D show example sponsor interface screens that provide segmented view information for paid versus organic views of video content items.

FIG. 3 is a flowchart of an example process for presenting information for paid versus organic views of video content items.

FIG. 4 is a block diagram of an example computer system that can be used to implement the methods, systems and processes described in this disclosure.

Like reference numbers and designations in the various drawings indicate like elements.

### DETAILED DESCRIPTION

This document describes methods, processes and systems for segmenting view information for video content items (e.g., video advertisements (or ads)) based on paid versus organic views. Paid views are video views that are associated with an advertisement, such as an advertisement for which a content sponsor pays for presentations of the advertisement. Organic views are views that occur as a result of direct navigation by a user to a hosting site for the video, without having linked there from an advertisement. For example, the paid views can correspond to paid presentations of the video content item, and organic views can correspond to views of the associated video that occur directly, for example, through a video sharing environment. Using the segmented view information, content sponsors (e.g., advertisers who sponsored the ads) can track the performance (e.g., views, etc.) of their video assets in both contexts. Further, the segmented view information can be filtered using various filters including, for example, demographics, location, time period (e.g., a range of dates/hours), and quartile (or dwell time while watching the video). For example, a sponsor can receive information that provides a segmented view of paid versus organic views of a particular video content item that was viewed in June by teenage girls from Omaha. The information can also include quartiles for the views, e.g., the number of views that completed one-fourth of the video, one-half, three-quarters, or the entire video.

As an example, view data that is identified for a video content item (e.g., teenage girls' boots) can be segmented. The segmented view data can create a segmentation that compares paid views versus organic views, e.g., whether the teenage girls' boots video was watched as part of a paid video ad or watched organically (unpaid) on a video hosting website. A user interface, e.g., used by the sponsor of the video content item, can present the segmented view data. In some implementations, a filter can be applied to the segmented view data, and the filtered sub-segments of the segmented view data can be presented to the user. In some implementations, segmented view data can include one or more segments that reflect view statistics of paid versus organic views for at least one or more of the following: demographics, time period, location, or dwell time.

In some implementations, filtering can also occur based on different video formats (e.g., search-result-embedded videos, selected-from-group videos, in-display videos, stream-embedded videos, or videos having other formats). As an example, a sponsor can be presented with segmented paid versus organic view information for a particular video content item's views that occurred as a search-result-embedded video or in other format(s) specified by the sponsor.

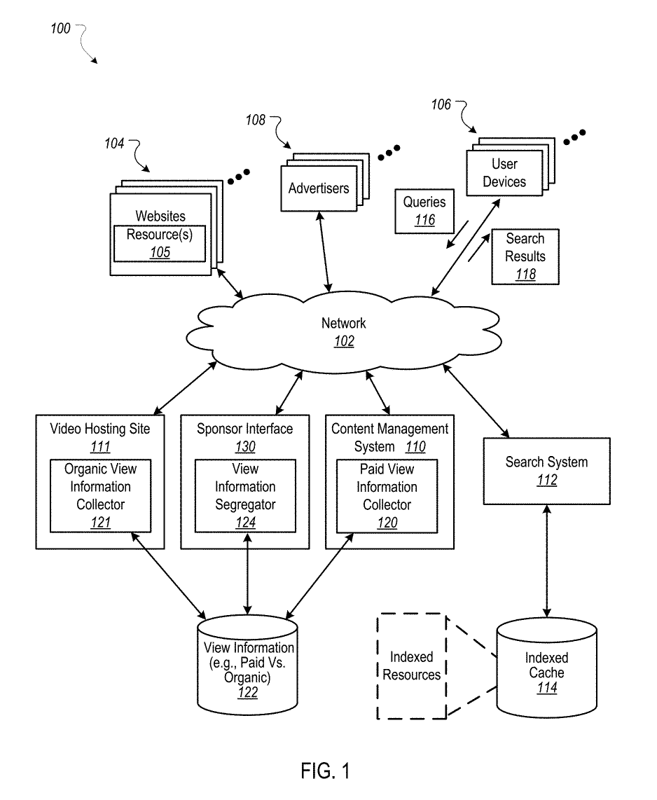

FIG. 1 is a block diagram of an example environment 100 for serving content. The example environment 100 includes a content management system 110 (e.g., for selecting and providing content in response to requests for content), a video hosting site 111 (e.g., a website for uploading and watching videos), and a sponsor interface 130 for presenting information for paid versus organic views of video content items. The example environment 100 includes a network 102, such as a local area network (LAN), a wide area network (WAN), the Internet, or a combination thereof. The network 102 connects websites 104, user devices 106, content sponsors (e.g., advertisers 108), publishers 109, the content management system 110, the video hosting site 111, and the sponsor interface 130. The example environment 100 may include many thousands of websites 104, user devices 106, and content sponsors (e.g., advertisers 108).

In some implementations, the content management system 110 includes a paid view information collector 120 that collects view information corresponding to paid views of video content items. The view information can be obtained, for example, from the content management system 110 which can track user presentations of (and reactions to) video content items. For example, when a video content item (e.g., a video ad) is presented, information about views of the video ad can be collected and stored, e.g., in a store of view information 122.

In some implementations, view information can include demographic, time period, location and/or dwell time information corresponding to each view. Any view information related to users can be anonymized so that the privacy of the users is protected. For example, quasi-unique identifiers can be associated with users, but the actual identifying information of the users is not stored in the view information 122. Additionally, any identified user interactions can be generalized (for example, generalized based on user demographics) rather than associated with a particular user. Encryption and obfuscation techniques can also be used to protect the privacy of users.

The video hosting site 111 can provide access to and allow playing of videos that have been uploaded by anyone, including individuals, content sponsors, etc. In some implementations, the video hosting site 111 can include an organic view information collector 121 that collects view information corresponding to organic (or unpaid) views of video content items that occur, for example, on the video hosting site 111. In some implementations, a particular video that a user can watch on the video hosting site 111 as an unpaid view can be the same video, for example, as one that is paid and is included as part of a video advertisement.

The view information 122 can include information regarding whether each view of a video has occurred as part of a paid ad impression or if the view was organic, e.g., requested by a user and not associated with an advertisement. In some implementations, the view information 122 can include statistics related to the number of times the video content item was presented, the number of times it was viewed by a user, the number of times the user interacted with (e.g., clicked on) the video content item causing the user to land on a landing page associated with the video content item, costs associated with the video content item, and so on.

In some implementations, the sponsor interface 130 includes a view information segregator 124 that segregates the collected view information relative to paid and organic views, e.g., using view information 122. The sponsor interface 130 can then present the segregated view information, e.g., in a user interface, in one or more reports, and/or in other ways.

In some implementations, the view information segregator 124 can segregate view information on an as-needed based, e.g., when the segregated information is requested for a user interface, report, etc. For example, real-time segregation can provide up-to-date information. In some implementations, segregation of the view information can occur on a scheduled basis (e.g., daily, hourly, etc.), and the information can be stored and ready-to-use, e.g., in a user interface that a content sponsor can use to review performance (e.g., number of views) of their video content items.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, videos and sounds, that may include embedded information (such as meta-information hyperlinks) and/or embedded instructions (such as JavaScript scripts).

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page or search results, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. In some implementations, the content management system 110 can generate search results 118 using information (e.g., identified resources) received from the search system 112. An example search result 118 can include a web page title or video title, a snippet of text or a portion of an image extracted from the web page or video, and the URL of the web page. Search results pages can also include one or more slots in which other content items (e.g., ads) can be presented.

When a resource 105, search results 118 and/or other content are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible video ads having characteristics matching the characteristics of ad slots and that are identified as relevant to specified resource keywords or search queries 116. However, in applications in which search queries 116 are not used, the content management system 110 can use other ways of selecting content, e.g., selecting ads based on the format type of a particular ad slot.

The content management system 110 can select from the eligible content items that are to be provided for presentation in slots of a resource or search results page based at least in part on results of an auction. For example, for the eligible content items, the content management system 110 can receive bids from content sponsors (e.g., advertisers) and allocate the slots, based at least in part on the received bids (e.g., based on the highest bidders at the conclusion of the auction). The bids are amounts that the content sponsors are willing to pay for presentation (or selection) of their content with a resource or search results page. For example, a bid can specify an amount that a content sponsor is willing to pay for playing a video associated with a video ad. Alternatively, the bid can specify an amount that the content sponsor is willing to pay for other activities such as a selection (i.e., a click-through) of the content item or a conversion following selection of the content item. The selected content item can be determined based on the bids alone, or based on the bids of each bidder being multiplied by one or more factors, such as quality scores derived from content performance, landing page scores, and/or other factors.

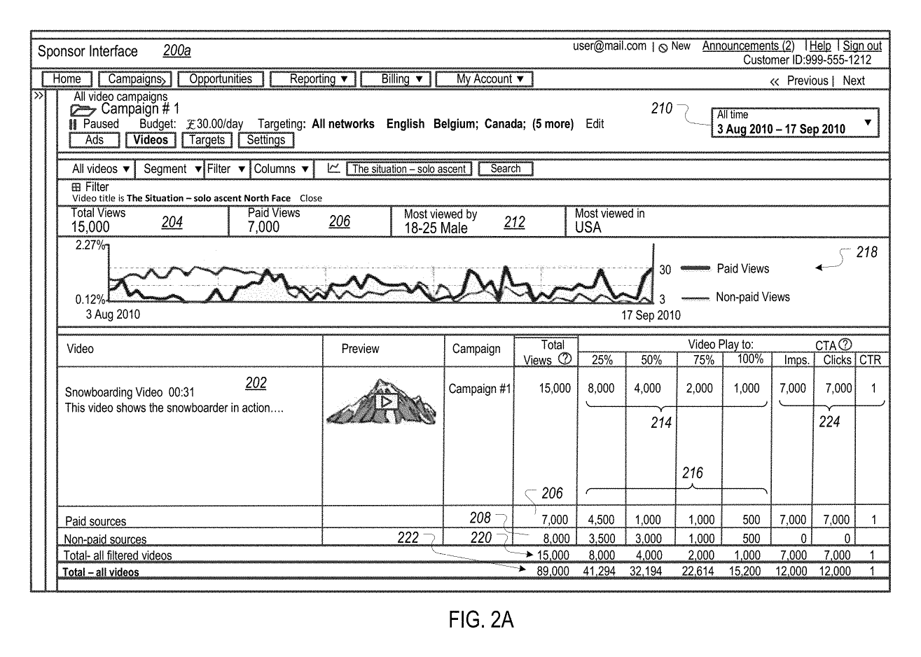

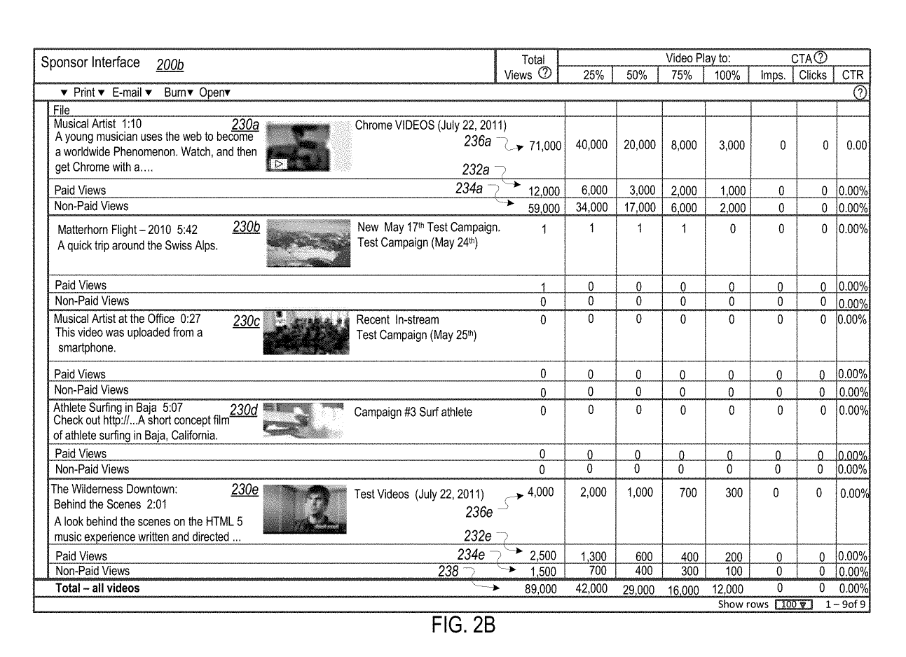

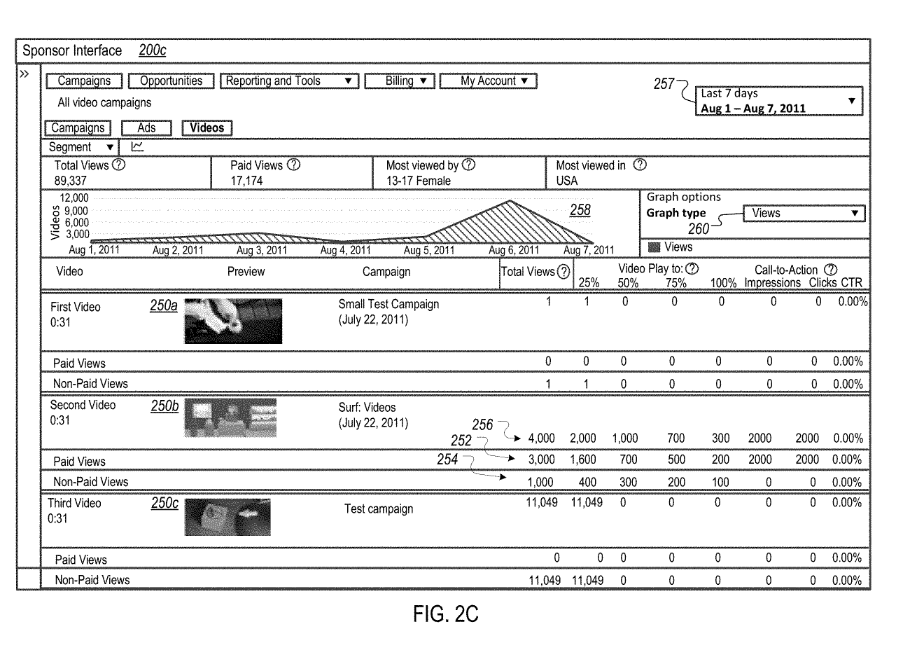

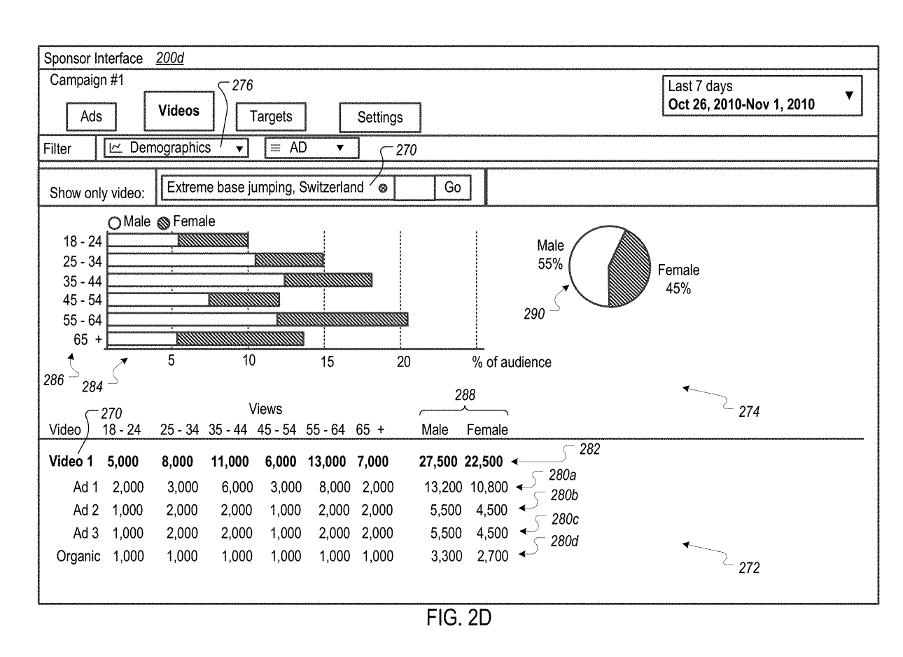

FIGS. 2A-2D show example sponsor interface screens 200a-200d that provide segmented view information for paid versus organic views of video content items. In some implementations, the sponsor interface 130 can provide the sponsor interface screens 200a-200d using information from view information 122, including information for paid and organic views. Other user interface screens are possible. In some implementations, the sponsor interface 130 can provide segmented view information in other formats, e.g., reports, emails, etc.

As an example, referring to FIG. 2A, the sponsor interface screen 200a displays segmented view information for a snowboarding video 202. The view information includes a total number of views 204 (e.g., 15,000 views), a paid view count 206 (e.g., 7,000 paid views), and an organic view count 208 (e.g., 8,000 un-paid views). In this example, a time period 210 states that the view information corresponds to a time period that spans Aug. 3 to Sep. 17, 2010. In some implementations, the time period 210 can be used as a filter for limiting the view information to a user-specified subset of views. Further, in this example, most views of the video 202 occurring during the time period 210 are associated with users in a particular demographic group 212 (e.g., males aged 18-25).

In some implementations, the time period 210, for example, can be a control that is used to select a time period to be used as a filter for one or more video content items. For example, the time period 210 can be applied as a filter to the segmented view data, so that presenting the user with paid versus organic view information can include presenting one or more filtered sub-segments of the segmented view in accordance with the time period filter. Other controls for selecting other filters are possible. For example, a demographic filter can be used that presents one more filtered sub-segments that can include presenting both organic view data and paid view data in accordance with the demographic filter. In some implementations, demographic filters can include filters based on age, gender, income, marital status, education, etc. In some implementations, the sponsor can select one or more demographic filters to use in selecting and/or segmenting view information according to the selections.

In some implementations, the filter can include a location filter. For example, presenting one more filtered sub-segments can include presenting both organic view data and paid view data in accordance with geographic location information. In some implementations, geographic location information can include countries, states, counties, neighborhoods, or other geographic areas.

In some implementations, the filter can include a quartile or dwell time filter. For example, presenting one more filtered sub-segments can include presenting both organic view data and paid view data in accordance with the quartile or dwell time filter.

For example, dwell time quartile information 214 (e.g., categorized by quartiles) identifies the number of views associated with users who watched 25%, 50%, 75% and 100% of the video, respectively. In some implementations, dwell time quartiles can be used as a filter. In this example, segmented quartile information 216 provides segmented quartile counts that are totaled for paid and organic views.

A line graph 218 shows a comparison of paid versus organic views over time. For example, the line graph 218 provides a segmented view of view information (e.g., paid versus organic) in graphical form. In some implementations, other forms of graphs can be used (e.g., bar charts, pie charts, etc.).

The snowboarding video 202 can be one of multiple videos that can appear on the sponsor interface screen 200a. In some implementations, view totals 220 and 222 can provide total views (and other totals) for all filtered views, e.g., the 15,000 views for paid plus organic, and all views, respectively. In this example, the view totals 222 correspond to sums of filtered views (e.g., between Aug. 3 to Sep. 17, 2010) and un-filtered views (e.g., outside of that time period).

In some implementations, additional statistics can be provided. For example, paid view statistics 224 can include statistics associated with impressions, clicks, and a click-through ratio (CTR) that correspond to the paid view count 206.

FIG. 2B shows an example sponsor interface screen 200b that displays segmented view information for videos 230a-230e. For example, paid view information 232a provides counts of paid views for the video 230a, including a total paid view count and dwell time quartiles. In another example, organic view information 234a provides counts of organic (un-paid) views for the video 230a, including a total organic view count and dwell time quartiles. Totals 236a, for example, provide totals of the paid view information 232a and the organic view information 234a. For the video 230e, totals 236e, for example, provide totals of paid view information 232e and organic view information 234e. In these examples, no time period filter or other filters are used.

A grand totals line 238 can provide totals corresponding to all videos, including totals for paid and organic views. For example, the grand totals line 238 can provide segmented totals of the segmented view information for videos 230a-230e and videos not shown in FIG. 2B but included in the totals (e.g., scrolled off the screen). In some implementations, paid and organic subtotals (not shown on FIG. 2B) can be used to provide subtotals across all videos, segmented by paid versus organic.

FIG. 2C shows an example sponsor interface screen 200c that displays segmented view information for videos 250a-250c. For example, paid view information 252 provides counts of paid views for the video 250b, including a total paid view count and dwell time quartiles. In another example, organic view information 254 provides counts of organic (un-paid) views for the video 250b, including a total organic view count and dwell time quartiles. Totals 256, for example, provide totals of the paid view information 252 and the organic view information 254.

In the example shown for videos 250a-250c, a time period filter 257 is used to limit the displayed view information, for example, to a views associated with a time period from Aug. 1-7, 2011. A line graph 258 also uses the time period range specified by the time period filter 257 to present filtered view information, as well as according to a selected graph type 260 (e.g., “Views”). Other selections for the graph type 260 can include, for example, “Paid Views,” “Non-paid Views” (e.g., for organic views), and “All Views” (e.g., for displaying two graph lines, one each for paid versus organic views, as shown for the line graph 218 of FIG. 2A.).

FIG. 2D shows an example sponsor interface screen 200d that displays segmented view information for a video 270. For example, the sponsor interface screen 200d can simultaneously display segmented view information in a table 272 and a graph 274. The segmented view information in the table 272 and the graph 274 is filtered based on a current setting (e.g., demographic) of a filter control 276. As a result, the view information in the table 272 and the graph 274 is segmented by demographic information in addition to whether the views are paid versus organic. In this example, the demographic filtering filters by age and gender.

For example, in the table 272, segmented view data for views associated with the video 270 is presented in tabular form. View information in the table, for example, corresponds to organic views and to views associated with three paid ads (e.g., Ad 1, Ad 2 and Ad 3) which are ads associated with a campaign 278 (e.g., Campaign 1). As a result, the table 272 includes separate lines 280a-280d showing view information for Ad 1, Ad 2, Ad 3 and organic views, respectively. A totals line 282 provides totals for the separate lines 280a-280d, where the totals correspond to the overall views for the video 270.

The graph 274 includes bars 284 that represent the number of male and female views for each age group 286 within the selected age demographic. The lengths of the bars 284 correspond to the number of views by age group in the table 272. Male/female totals 288 in the table 272 correspond to total views segmented by gender and based on male/female view totals on each of the separate lines 280a-280d. A pie chart 290, indicating a male/female percentage split of views, is based on total male and female views (e.g., 27,500 and 22,500) for the video 270 that appear on the totals line 282.

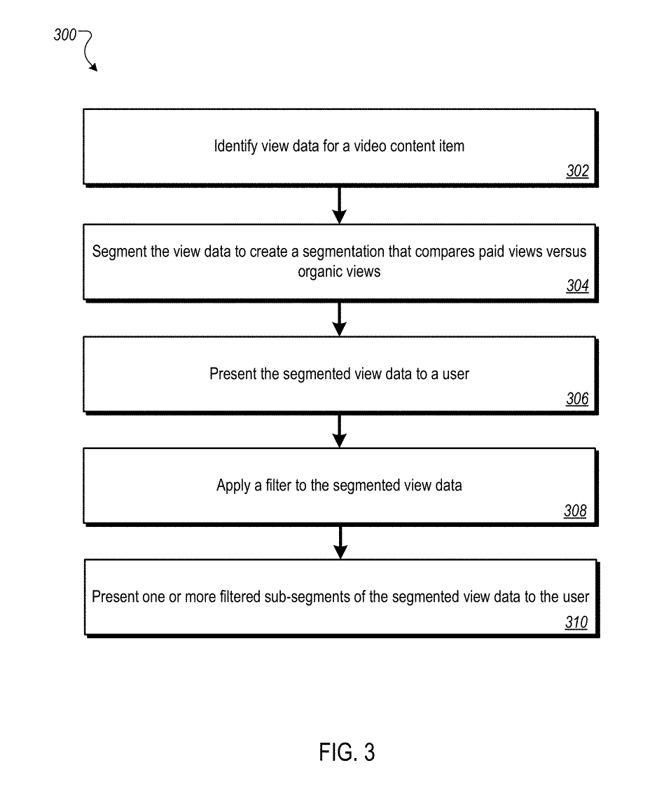

FIG. 3 is a flowchart of an example process 300 for presenting information for paid versus organic views of video content items. The process 300 can be performed by one or more processors associated with the sponsor interface 130. FIGS. 1 and 2A-2D are used to provide examples for steps of the process 300.

View data is identified for a video content item (302). For example, the content management system 110 can identify one or more video content items for which paid and/or organic views have occurred. In some implementations, the content management system 110 can provide the view identification for the video content items to the paid view information collector 120. In some implementations, the paid view information collector 120, for example, can set up buckets used by the view information 122 in preparation of collecting view information for the video content items, including information that identifies whether each view is a paid view or an organic view. The collection of view information can occur over time as each video content item is presented to potentially thousands or millions of users. As an example, the paid view information collector 120 can collect view information corresponding to paid views, e.g., views of the video content item that occur in association with a paid ad. The organic view information collector 121, for example, can collect view information corresponding to organic views of the video content item, e.g., unpaid views of the associated video that occur on the video hosting site 111. The collected view information can also include information regarding user actions that occur after the video content item is presented (e.g., dwell time, impressions, click-throughs, etc.).

The view data is segmented to create a segmentation that compares paid views versus organic views (304). As an example, the view information segregator 124 can segregate the collected view information relative to paid versus organic views and provide totals relative to the video content item as a whole. In some implementations, the view information segregator 124 can access view information 122 for each of the paid and organic views.

The segmented view data is presented to a user (306). For example, the sponsor interface 130 can present the segmented information in any of the sponsor interface screens 200a-200d, in a report, or in other ways.

A filter is applied to the segmented view data (308). As an example, the view information segregator 124 can use one or more filters (e.g., demographics, time period, location, or dwell time) to create sub-segments of the view information that is already segmented based by paid versus organic views.

One or more filtered sub-segments of the segmented view data are provided to the user (310). As an example, referring to FIG. 2D, the sponsor interface screen 200d can present view information upon which age and gender demographic filters have been applied. Specifically, the table 272 and the graph 274 are segmented by age and gender in various ways. This filter-based segmentation is in addition to segmentation based on paid versus organic views.

In some implementations, filtering can also occur based on video format. Different types of video formats can exist, including, but not limited to, a search-result-embedded format (e.g., a video that is provided as part of a search result), a selected-from-group format (e.g., a video that is provided in response to a selection made from a slate of available videos), an in-display format (e.g., a video that is provided as a user-selectable thumbnail within a banner or other display), or a stream-embedded format (e.g., a video that is provided before, during or after another content item in a stream). Other formats are possible. Each format can provide a different context in which the video content item is presented. By way of example, search-result-embedded videos can include videos that consist of a user-selectable thumbnail image or icon that appears inside a search result. Selected-from-group videos can include videos that result from user selection of a single thumbnail from a group (or slate) of thumbnails of videos. In-display videos can include videos that appear as a user-selectable thumbnail in a banner (e.g., at the top of a web page) or in some other type of display. Stream-embedded videos can include short (e.g., 15-second, 30-second, etc.) videos that play before, during or after other video content (e.g., referred to as “pre-rolls,” “mid-rolls,” or “post-rolls”). Other formats are possible, and the methods, systems, user interfaces, etc. that are described in this document can be adapted for the other formats, including formats that apply to mobile devices.

One or more filtered sub-segments of the segmented view data are presented to the user (310).

While reference is made to paid versus organic segmentations of the view data, other segmentations are possible. For example, the systems and methods proposed could be used to segment views from multiple different serving sources (e.g., from different content delivery systems). Other segmentations are possible.

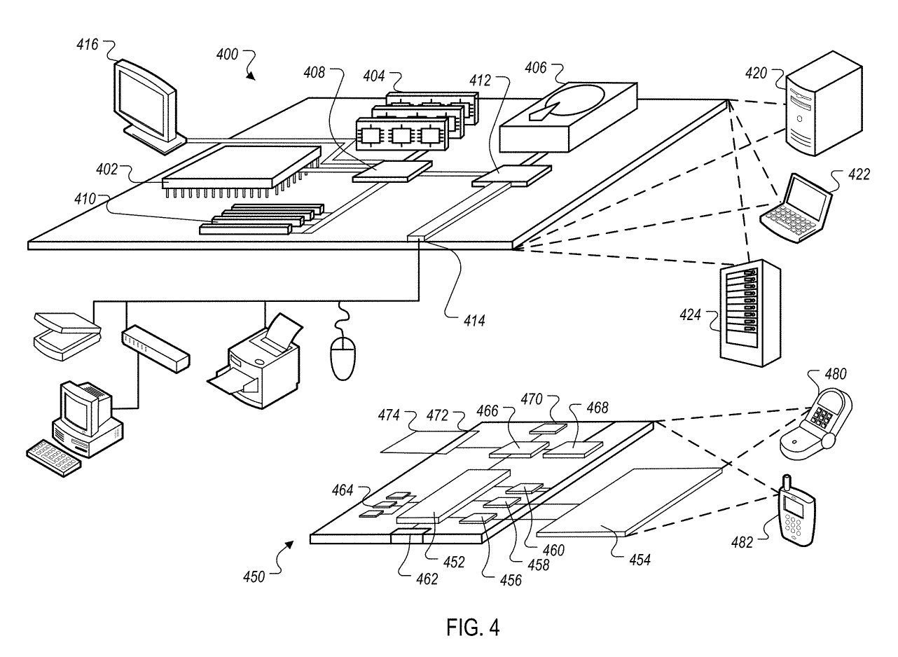

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
determining, by a processing device, view data for a video content item, wherein determining the view data comprises:
determining, by the processing device, a number of times the video content item was presented as part of a video advertisement;
determining, by the processing device, a number of times the video content item was presented as not part of any video advertisement;
determining, by the processing device, a number of times the video content item presented as part of a video advertisement was viewed, including views associated with reaching specific percentages of a length of the video content item;
determining, by the processing device, a number of times the video content item presented as not part of any video advertisement was viewed, including views associated with reaching the specific percentages of the length of the video content item;
determining, by the processing device, a number of times the video content item presented as part of a video advertisement was interacted with by users to cause a landing page associated with the video content item to be displayed to the users; and
determining, by the processing device, a number of times the video content item presented as not part of any video advertisement was interacted with by users to cause a landing page associated with the video content item to be displayed to the users;
segmenting, by the processing device, the view data to create a segmentation that compares paid views of the video content item versus organic views of the same video content item, wherein each paid view of the video content item occurred when the video content item was presented as part of a video advertisement, and wherein each organic view of the same video content item occurred when the same video content item was not part of any video advertisement; and
providing, by the processing device, a graphical user interface (GUI) to present the segmented data to a user, wherein the GUI comprises a time period, a title of the video content item, a number of paid views of the video content item that occurred during the time period, numbers of paid views associated with reaching the specific percentages of the length of the video content item that occurred during the time period, a number of times the video content item presented as part of a video advertisement during the time period was interacted with by users to cause a landing page associated with the video content item to be displayed to the users, a number of organic views of the video content item that occurred during the time period, numbers of organic views associated with reaching the specific percentages of the length of the video content item that occurred during the time period, and a number of times the video content item presented as not part of any video advertisement during the time period was interacted with by users to cause a landing page associated with the video content item to be displayed to the users, the GUI further displaying an image representing the video content item with a GUI element selectable to view the video content item.

2. The method of claim 1 further comprising:
applying a filter to the segmented view data; and
presenting one or more filtered sub-segments of the segmented view data to the user.

3. The method of claim 2 where the filter is a demographic filter and presenting one more filtered sub-segments includes presenting both organic view data and paid view data in accordance with the demographic filter.

4. The method of claim 2 where the filter is a location filter and presenting one more filtered sub-segments includes presenting both organic view data and paid view data in accordance with the location filter.

5. (canceled)

6. The method of claim 2 where the filter is a quartile or dwell time filter and presenting one more filtered sub-segments includes presenting both organic view data and paid view data in accordance with the quartile or dwell time filter.

7. The method of claim 1 where the view data includes both paid view data for paid presentations of the video content item and organic view data for views of the same video content item directly through a video sharing environment.

8. The method of claim 1 where presenting the segmented view data includes presenting the segmented view data in a graph.

9. The method of claim 1 where presenting the segmented view data includes presenting the segmented view data in a tabular form.

10. The method of claim 1 further comprising further segmenting the segmented view data to include one or more segments that reflect view statistics of paid versus organic views for at least one or more of the following further segments comprising demographics, time period, location, or dwell time.

11. A system comprising:
a memory to store view data for a video content item including view information corresponding to paid views of the video content item, and view information corresponding to organic views of the video content item; and
a processing device coupled to the memory to:
determine the view data for the video content item, wherein to determine the view data, the processing device is to:
determine a number of times the video content item was presented as part of a video advertisement;
determine a number of times the video content item was presented as not part of any video advertisement;
determine a number of times the video content item presented as part of a video advertisement was viewed, including views associated with reaching specific percentages of a length of the video content item;
determine a number of times the video content item presented as not part of any video advertisement was viewed, including views associated with reaching the specific percentages of the length of the video content item;
determine a number of times the video content item presented as part of a video advertisement was interacted with by users to cause a landing page associated with the video content item to be displayed to the users; and
determine a number of times the video content item presented as not part of any video advertisement was interacted with by users to cause a landing page associated with the video content item to be displayed to the users;
segment the view data to create a segmentation that compares paid views of the video content item versus organic views of the same video content item, wherein each paid view of the video content item occurred when the video content item was presented as part of a video advertisement, and wherein each organic view of the same video content item occurred when the same video content item was not part of any video advertisement; and
provide a sponsor interface, displayable on a user device, for presenting the segmented view data to a user, the sponsor interface comprising a time period, a title of the video content item, a number of paid views of the video content item that occurred during the time interval and a number of organic views of the video content item that occurred during the time interval, numbers of paid views associated with reaching the specific percentages of the length of the video content item that occurred during the time period, a number of times the video content item presented as part of a video advertisement during the time period was interacted with by users to cause a landing page associated with the video content item to be displayed to the users, a number of organic views of the video content item that occurred during the time period, numbers of organic views associated with reaching the specific percentages of the length of the video content item that occurred during the time period, and a number of times the video content item presented as not part of any video advertisement during the time period was interacted with by users to cause a landing page associated with the video content item to be displayed to the users, the sponsor interface further comprising an image representing the video content item with a user interface element selectable to view the video content item.

12. The system of claim 11 where the processing device is further to:
apply a filter to the segmented view data; and
present one or more filtered sub-segments of the segmented view data for use in the sponsor interface.

13. A non-transitory computer-readable storage medium comprising instructions that, when executed by a processor, cause the processor to:
determine view data for a video content item, wherein to determine the view data, the processor is to:
determine a number of times the video content item was presented as part of a video advertisement;
determine a number of times the video content item was presented as not part of any video advertisement;
determine a number of times the video content item presented as part of a video advertisement was viewed, including views associated with reaching specific percentages of a length of the video content item;
determine a number of times the video content item presented as not part of any video advertisement was viewed, including views associated with reaching the specific percentages of the length of the video content item;
determine a number of times the video content item presented as part of a video advertisement was interacted with by users to cause a landing page associated with the video content item to be displayed to the users; and
determine a number of times the video content item presented as not part of any video advertisement was interacted with by users to cause a landing page associated with the video content item to be displayed to the users;
segment the view data to create a segmentation that compares paid views of the video content item versus organic views of the same video content item, wherein each paid view of the video content item occurred when the video content item was presented as part of a video advertisement, and wherein each organic view of the same video content item occurred when the same video content item was not part of any video advertisement; and
provide a graphical user interface (GUI) to present the segmented data to a user, wherein the GUI comprises a time interval, a title of the video content item, a number of paid views of the video content item that occurred during the time interval and a number of organic views of the video content item that occurred during the time interval, numbers of paid views associated with reaching the specific percentages of the length of the video content item that occurred during the time period, a number of times the video content item presented as part of a video advertisement during the time period was interacted with by users to cause a landing page associated with the video content item to be displayed to the users, a number of organic views of the video content item that occurred during the time period, numbers of organic views associated with reaching the specific percentages of the length of the video content item that occurred during the time period, and a number of times the video content item presented as not part of any video advertisement during the time period was interacted with by users to cause a landing page associated with the video content item to be displayed to the users, the GUI further displaying an image representing the video content item with a GUI element selectable to view the video content item.

14. The non-transitory computer-readable storage medium of claim 13 further comprising instructions to:
apply a filter to the segmented view data; and
present one or more filtered sub-segments of the segmented view data to the user.

15. The non-transitory computer-readable storage medium of claim 14 where the filter is a demographic filter and presenting one more filtered sub-segments includes presenting both organic view data and paid view data in accordance with the demographic filter.

16. The non-transitory computer-readable storage medium of claim 14 where the filter is a location filter and presenting one more filtered sub-segments includes presenting both organic view data and paid view data in accordance with the location filter.

17. (canceled)

18. The non-transitory computer-readable storage medium of claim 14 where the filter is a quartile or dwell time filter and presenting one more filtered sub-segments includes presenting both organic view data and paid view data in accordance with the quartile or dwell time filter.

19. The non-transitory computer-readable storage medium of claim 13 where the view data includes both paid view data for paid presentations of the video content item and organic view data for views of the same video content item directly through a video sharing environment.

20. The non-transitory computer-readable storage medium of claim 13 where presenting the segmented view data includes presenting the segmented view data in a graph.

21. The non-transitory computer-readable storage medium of claim 13 where presenting the segmented view data includes presenting the segmented view data in a tabular form.

22. The non-transitory computer-readable storage medium of claim 13 further comprising instructions to further segment the segmented view data to include one or more segments that reflect view statistics of paid versus organic views for at least one or more of the following further segments comprising demographics, time period, location, or dwell time.
